(19) United States
(12) Patent Application Publication
(10) Pub. No.: US 2010/0271702 A1
(43) Pub. Date: Oct. 28, 2010

(54) LOW BIREFRINGENT THERMOPLASTIC LENSES AND COMPOSITIONS USEFUL IN PREPARING SUCH LENSES

(75) Inventors: Weijun Zhou, Lake Jackson, TX (US); Stephen F. Hahn, Midland, MI (US); Charles F. Diehl, Blue Bell, PA (US); Kurt A. Koppi, Midland, MI (US)

Correspondence Address: The Dow Chemical Company, P.O. BOX 1967, Midland, MI, 48641, US

(73) Assignee: Dow Global Technologies Inc., Midland, MI (US)

(21) Appl. No.: 12/810,030

(22) PCT Filed: Sep. 18, 2008
(86) PCT No.: PCT/US08/76821

§ 371 Date: Jun. 22, 2010

Related U.S. Application Data
(60) Provisional application No. 61/017,253, filed on Dec. 28, 2007.

(51) Int. Cl. G02B 1/11; C08F 236/10; B29D 11/00

(52) U.S. Cl. 359/581; 525/332.9; 264/1.1

(57) ABSTRACT

A lens-forming thermoplastic composition of matter has a crystallinity, as determined in accord with differential scanning calorimetry of from 0 percent to less than 1 percent when the composition comprises a hydrogenated vinyl aromatic/isoprene block copolymer or a crystallinity, as determined in accord with differential scanning calorimetry of from more than 0 percent to less than 1 percent when the composition comprises a hydrogenated vinyl aromatic/butadiene block copolymer. The composition has a birefringence, measured at a wavelength of 633 nanometers, within a range of from 0 to less than 6×10. Molding a melt of these compositions occurs at temperatures within a range from the hydrogenated block copolymer's glass transition minus 20° C. to the glass transition temperature minus 90° C. The compositions suitably form lenses such as an optical pick-up lens, which may be aspherical or have at least one of an irregular surface configuration, a non-uniform thickness or an irregular and non-uniform cross-section.

### CROSS-REFERENCE TO PRIOR APPLICATION

This application claims the benefit of U.S. Provisional Application No. 61/017,253 filed Dec. 28, 2007.

This invention relates to plastic lenses and thermoplastic polymer compositions or thermoplastic polymer blend compositions useful in preparing such lenses. This invention relates more particularly to a lens-forming, thermoplastic composition of matter comprising a hydrogenated vinyl aromatic block copolymer, especially a hydrogenated vinyl aromatic/butadiene block copolymer or a hydrogenated vinyl aromatic/isoprene block copolymer.

Optical pick up devices used to record data on or read the data from recording media such as compact disks (CD), or digital video disks (DVD) commonly employ plastic or polymeric lenses. Other common lenses include, but are not limited to, f-theta lenses, lenses for camera phone, and lenses for digital cameras, both still photo and video.

As technology advances, there appears to be a demand to both increase operating speed of optical pick up devices and decrease weight of actuators that embody such devices. This translates, at least in part, to a rising demand for lenses that deliver improved performance while decreasing in size (both diameter and thickness) and weight. In addition to a trend toward decreased size and weight, a developing trend exists for an optical lens having an uneven thickness or an aspherical shape. These trends accompany demands for excellence in physical performance criteria such as optical purity or clarity, impact resistance, and low birefringence, with “low birefringence” being as close to zero as possible, e.g. a range of from 0 or slightly greater than 0 to 6×10⁻⁶.

As desire to improve or increase recording density of optic or optical media deepens and accompanies the above demands, a growing trend exists that favors movement toward shorter wavelengths. While a number of current lens applications allow use of wavelengths in the red region of the visible light spectrum, especially the red laser light range, e.g. 633 nanometers (nm), the shorter wavelengths include those in the blue light (e.g. blue laser light) range, nominally from 350 nm to 450 nm.

In addition to promoting ever improved physical property performance from thermoplastic lenses, fabricators continue to seek thermoplastic resins or thermoplastic resin compositions capable of delivering that performance. At the same time, fabricators press for economically short cycle times, where cycle time begins with molten resin or resin composition and ends with removal of a fabricated article, in this case a lens, from an apparatus (e.g. an injection molding device) used to fabricate the article. A cycle time of, for example, several seconds (e.g. 5 seconds to 15 seconds) allows for substantially more product output than a longer cycle time on the order of several minutes.

Currently available “low birefringence” polymer resins tend to be very brittle and current polymeric lens materials that have sufficient ductility to overcome brittleness challenges tend to have a birefringence that is not low enough birefringence for many end use applications, especially optical lens applications. Brittleness of such low birefringence polymer resins translates to molding problems such as sprue breakage during lens molding operations. Sprue breakage, in turn, leads to interruptions in continuous molding operations, thereby effectively reducing production output from a maximum or machine-rated capacity to a lower and less desirable level

A first aspect of this invention is a thermoplastic composition of matter, preferably a lens-forming, thermoplastic composition of matter, the composition having a crystallinity of from greater than 0 percent to less than 1 percent, in each case as measured in accord with differential scanning calorimetry (DSC), and an average birefringence, measured at a wavelength of 633 nm, within a range of from 0 to less than 6×10⁻⁶. The composition preferably comprises a hydrogenated vinyl aromatic block copolymer, more preferably a hydrogenated vinyl aromatic/butadiene block copolymer, and still more preferably a hydrogenated styrene/butadiene block copolymer. Such a block copolymer contains a hydrogenated polystyrene component, which is amorphous, and can contain a hydrogenated polydiene component that can be crystalline or amorphous.

A second aspect of this invention is a thermoplastic composition of matter, preferably a lens-forming, thermoplastic composition of matter, the composition comprising a hydrogenated vinyl aromatic monomer/conjugated diene block copolymer that has a crystallinity of from 0 percent, as measured in accord with DSC, to less than 1 percent, and an average birefringence, measured at a wavelength of 633 nm, within a range of from 0 to less than 6×10⁻⁶. The conjugated diene is preferably selected from butadiene, isoprene or a mixture of butadiene and isoprene. Butadiene, when present, is suitably present in an amount sufficient to provide the block copolymer with a crystallinity of more than 0 percent. When isoprene is present as a sole conjugated diene, the crystallinity is 0 percent.

A third aspect of this invention is a method of preparing a lens, preferably an optical lens and more particularly an optical pick-up lens, the method comprising:

a. providing a polymer melt that comprises a hydrogenated vinyl aromatic block copolymer that has a crystallinity of from 0 percent to less than 1 percent, in each case as measured in accord with differential scanning calorimetry (DSC), an average birefringence, measured at a wavelength of 633 nm, within a range of from 0 to less than 6×10⁻⁶, and a glass transition temperature within a range of from 115° C. to 145° C., and the polymer melt being at a melt temperature sufficient to provide a flowable viscosity, yet insufficient to cause heat-induced copolymer chain scission or degradation;

b. molding the polymer melt into a lens at a mold temperature within a temperature range of from the glass transition temperature minus 20° C. to the glass transition temperature minus 90° C., whereby the lens has a substantially uniform birefringence throughout its cross-section (from top to bottom thereof) and across its length and width.

Selection of diene monomer for a hydrogenated vinyl aromatic/diene block copolymer affects both whether crystallinity exists and, if it exists, extent of crystallinity and thus the birefringence. For example, hydrogenated polyisoprene has an alternating poly(ethylene-alt-propylene) repeat unit structure, which exhibits no discernible, at least by current technology, crystallinity Hydrogenated polybutadiene has a poly(ethylene-co-butene) repeat unit structure that can exhibit crystallinity due to the polyethylene component. Accordingly, a blend of isoprene and butadiene, after hydrogenation, has a crystallinity intermediate between zero and that delivered by a pure hydrogenated polybutadiene component. When butadiene is present, at least present in an amount sufficient to impart a measurable degree of crystallinity after hydrogenation, birefringence exceeds 0, but still remains less than 6×10⁻⁶. When isoprene is the sole diene, crystallinity equals zero after hydrogenation. A crystallinity of zero does not, however, equate to a birefringence of 0 due, at least in part, to birefringence resulting from, for example, anisotropic polymer chain orientation during fabrication and/or block copolymer morphology that exists in a fabricated article.

A fourth aspect of this invention is a lens, preferably an optical pick-up lens, the lens comprising the hydrogenated vinyl aromatic block copolymer of either the first aspect or the second aspect, and having at least one of a) a thickness of more than one millimeter (mm) and b) a substantially uniform birefringence throughout its cross-section and across its length and width. One may also use a blend of the hydrogenated vinyl aromatic block copolymers of the first and second aspects. In addition, one may add a hydrogenated vinyl aromatic homopolymer or a hydrogenated random copolymer of a vinyl aromatic monomer and a conjugated diene monomer to any of the hydrogenated block copolymer of the first aspect or the hydrogenated block copolymer of the second aspect or to the blend of hydrogenated block copolymers of the first and second aspects.

The compositions of matter for both the first aspect and the second aspect have utility in forming polymeric or plastic lenses, especially lenses used in optical pick-up devices, cameras and cell phones. Optical pick-up devices typically find use in recording data on, or reading data from, recording media such as compact discs (CDs) and digital video discs (DVDs). Additional utilities include projector lenses and optical components such as optical waveguides and Fresnel plates.

When ranges are stated herein, as in a range of from 2 to 10, both end points of the range (e.g. 2 and 10) and each numerical value, whether such value is a rational number or an irrational number, are included within the range unless otherwise specifically excluded.

References to the Periodic Table of the Elements herein shall refer to the Periodic Table of the Elements, published and copyrighted by CRC Press, Inc., 2003. Also, any references to a Group or Groups shall be to the Group or Groups reflected in this Periodic Table of the Elements using the IUPAC system for numbering groups.

Unless stated to the contrary, implicit from the context, or customary in the art, all parts and percents are based on weight. For purposes of United States patent practice, the contents of any patent, patent application, or publication referenced herein are hereby incorporated by reference in their entirety (or the equivalent US version thereof is so incorporated by reference) especially with respect to the disclosure of synthetic techniques, definitions (to the extent not inconsistent with any definitions provided herein) and general knowledge in the art.

The term “comprising” and derivatives thereof does not exclude the presence of any additional component, step or procedure, whether or not the same is disclosed herein. In order to avoid any doubt, all compositions claimed herein through use of the term “comprising” may include any additional additive, adjuvant, or compound whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or”, unless stated otherwise, refers to the listed members individually as well as in any combination.

Expressions of temperature may be in terms either of degrees Fahrenheit (° F.) together with its equivalent in ° C. or, more typically, simply in ° C.

The thermoplastic composition of matter of the first aspect comprise a hydrogenated vinyl aromatic block copolymer that has a crystallinity of from greater than 0 percent, as measured in accord with differential scanning calorimetry (DSC), to less than 1 percent, and an average birefringence, measured at a wavelength of 633 nm, within a range of from 0 to less than 6×10⁻⁶. While similar, the thermoplastic composition of matter of the second aspect differs from that of the first aspect in that crystallinity may equal zero, thereby eliminating crystallinity-induced or crystallinity-related birefringence and providing an opportunity for lower total birefringence than that attainable when crystallinity and crystallinity-induced birefringence are present. For both the first and second aspects, the composition of matter is preferably a lens-forming composition of matter.

As noted above, choice of diene monomer affects whether a block copolymer, subsequent to hydrogenation, has any crystallinity and, therefore, any crystallinity related-birefringence. Accordingly, the block copolymer of the first aspect and the block copolymer of the second aspect where crystallinity and crystallinity-related birefringence exceed zero, have, prior to hydrogenation, an amount of polymerized butadiene monomer present in a block length that is long enough to provide a measurable level of crystallinity Such a block length, following hydrogenation, translates to an ethylene chain length of sufficient length to provide the measurable level of crystallinity. When the sole diene is isoprene, both crystallinity and crystallinity-related birefringence equal zero. One may also attain a crystallinity of zero even when the block copolymer, prior to hydrogenation, contains an amount of polymerized butadiene monomer provided the amount of polymerized butadiene monomer present in a block length is too short to provide a measurable level of crystallinity and/or the block that contains, prior to hydrogenation, butadiene has a 1,2-vinyl content in excess of 20 wt %, based upon total butadiene content of the block copolymer prior to hydrogenation.

The hydrogenated block copolymers of both the first aspect and the second aspect preferably comprise pentablock copolymers. The preferred pentablock copolymers, prior to hydrogenation, comprise at least three distinct blocks of polymerized and hydrogenated vinyl aromatic monomer and at least two blocks of polymerized and hydrogenated conjugated diene monomer. The blocks of polymerized and hydrogenated vinyl aromatic monomer alternate with the blocks of polymerized and hydrogenated conjugated diene monomer such that the blocks of polymerized and hydrogenated vinyl aromatic monomer constitute end blocks of such hydrogenated block copolymers. Using a convention where “V” represents a polymerized and hydrogenated vinyl aromatic monomer (e.g. styrene) block and “D” represents a polymerized and hydrogenated diene block (e.g. butadiene and/or isoprene), such a pentablock copolymer may be represented as “VDVDV”.

For the hydrogenated block copolymer of the first aspect, the diene monomer comprises butadiene and the polymerized diene monomer content is from greater than 5 percent by weight (wt %) to less than 20 wt %, based upon total block copolymer weight. When the polymerized diene monomer content is greater than 15 wt % but less than 20 wt %, the polymerized diene monomer comprises at least 15 wt % of 1,2-vinyl incorporation and less than 85 wt % of 1,4-butadiene incorporation, the wt % of 1,2-vinyl incorporation and the wt % of 1,4-butadiene incorporation being based upon total polymerized diene monomer content and, when taken together, totaling 100 wt %.

For the hydrogenated block copolymer of the second aspect, the block copolymer, prior to hydrogenation has a polymerized vinyl aromatic monomer (preferably styrene) content of from more than 70 percent by weight (wt %) to less than 95 wt %, preferably from more than 80 wt % to less than 95 wt %, and a polymerized diene monomer content, preferably a polymerized isoprene of from more than 5 wt % to less than 30 wt %, preferably from more than 5 wt % to less than 20 wt %, each wt % being based upon total block copolymer weight, provided polymerized vinyl aromatic monomer content and polymerized diene monomer content, when taken together, equal 100 wt %.

The hydrogenated block copolymers of the first and second aspects, wherein the diene monomer is either butadiene or isoprene, preferably have, prior to hydrogenation, a number average molecular weight (Mₙ) within a range of from 40,000 to less than 150,000. The range is preferably from 45,000 to 120,000. The hydrogenated block copolymers preferably have a hydrogenation level of at least 90 percent, preferably at least 95 percent In addition, such block copolymers have an unnotched izod impact of at least 1.8 foot pounds per inch (ft-lb/in) (95.9 Joules per meter (J/m).

The hydrogenated block copolymers of the first and second aspects preferably have a hydrogenation level of at least 90 wt % for both vinyl aromatic blocks and conjugated diene blocks. The hydrogenation level for vinyl aromatic blocks is more preferably at least 95 wt %, still more preferably at least 98 wt % and yet more preferably at least 99 wt %, each wt % being based upon total aromatic double bonds (unsaturation) present in the block copolymer prior to hydrogenation. The hydrogenation level for conjugated diene blocks is more preferably at least 95 wt % and still more preferably at least 98 wt %, each wt % being based upon total aliphatic (non-aromatic) double bonds (unsaturation) present in the block copolymer prior to hydrogenation.

The hydrogenated block copolymers of the first and second aspect preferably have, especially when converted to an injection molded article of manufacture such as a polymeric lens, an unnotched Izod impact of at least 1.8 ft-lb/inch (95.9 J/m), more preferably at least 2.0 ft-lb/inch (106.6 J/m).

The method of the third aspect comprises:

a. providing a polymer melt that comprises a hydrogenated vinyl aromatic block copolymer that has a crystallinity of from 0 percent to less than 1 percent, in each case as measured in accord with DSC, a birefringence, measured at a wavelength of 633 nm of from 0 to less than 6×10⁻⁶, and a glass transition temperature within a range of from 115° C. to 145° C., and the polymer melt being at a melt temperature sufficient to provide a flowable viscosity, yet insufficient to cause heat-induced copolymer chain scission or degradation;

b. molding the polymer melt into a lens, preferably an optical lens and more particularly an optical pick-up lens, at a temperature within a temperature range of from the glass transition temperature minus 20° C. to the glass transition temperature minus 90° C., whereby the optical pick-up lens has a substantially uniform birefringence throughout its cross-section (from top to bottom thereof) and across its length and width. The molded lens, especially optical pick-up lenses, have a thickness of at least one millimeter and a birefringence of from greater than 0 to less than 6×10⁻⁶. The polymer melt is preferably at a temperature within a range of from 200° C. to less than 310° C., more preferably from 220° C. to less than 310° C., and still more preferably from 220° C. to 290° C. Other preferred process conditions include a step b. that occurs in a mold cycle time of less than one minute, more preferably less than or equal to 45 seconds, still more preferably less than or equal to 30 seconds and even more preferably less than or equal to 15 seconds, and a step b. mold temperature of less than 100° C., preferably less than or equal to 95° C., and more preferably less than or equal to 85° C. The mold cycle time is desirably greater than or equal to one second.

The hydrogenated vinyl aromatic block copolymer used in one variation of the method of the third aspect is, prior to hydrogenation, a styrene/isoprene block copolymer, more preferably a styrene/isoprene pentablock copolymer. The hydrogenated vinyl aromatic block copolymer used in a second variation of the method of the third aspect is, prior to hydrogenation, a styrene/butadiene block copolymer, more preferably a styrene/isoprene pentablock copolymer. In a third variation of the method of the third aspect, one may use a first hydrogenated vinyl aromatic block copolymer that, prior to hydrogenation, comprises a styrene/isoprene block copolymer, preferably a styrene/isoprene pentablock copolymer, in admixture with a second hydrogenated vinyl aromatic block copolymer that, prior to hydrogenation, comprises a styrene/butadiene block copolymer, preferably a styrene/butadiene pentablock copolymer. As noted above, when the hydrogenated vinyl aromatic block copolymer, prior to hydrogenation, comprises a styrene/butadiene block copolymer, the crystallinity can be greater than 0. Also as noted above, one may add an amount of a vinyl aromatic block copolymer, which prior to hydrogenation, is a styrene/butadiene block copolymer in order to attain a crystallinity of more than 0. Further as noted above, when the vinyl aromatic block copolymer used in the polymer melt contains, prior to hydrogenation, isoprene as a sole conjugated diene, the crystallinity is 0.

The fourth aspect of this invention is a lens, preferably an optical lens and more preferably an optical pick-up lens. The lens preferably comprises the hydrogenated vinyl aromatic block copolymer of either the first aspect or the second aspect. The lens has an average birefringence, measured at a wavelength of 633 nm of from greater than 0 to less than 6×10⁻⁶. The lens preferably has at least one of a) a thickness of more than one millimeter and b) a substantially uniform birefringence throughout its cross-section and across its length and width. The lens preferably has a thickness of at least one millimeter (mm), more preferably at least 1.2 mm.

The hydrogenated vinyl aromatic block copolymer used in the lens of the fourth aspect may also be any of those enumerated above for use in the method of the third aspect.

Preferred lenses have at least one of an irregular surface configuration, a non-uniform thickness or an irregular and non-uniform cross-section. As used herein, “substantially uniform birefringence” means a standard deviation of less than or equal to 3×10⁻⁶. Aspherical lenses represent an especially preferred group of lenses. The birefringence of such lenses may also be determined in response to blue laser light. Blue laser light has a wavelength within a range of from 350 nm to 450 nm.

The lens of the fourth aspect preferably further comprises an anti-reflective coating that is deposited on at least one surface portion of the lens. The anti-reflective coating more preferably comprises a thin (e.g.50 nanometers (nm) to 150 nm) film that is vapor deposited from common low refractive index oxides or fluorides including, but not limited to, silicon oxide, hafnium oxide, magnesium fluoride, and mixtures thereof. The anti-reflective coating may comprise either a single layer or a combination of multiple, preferably thin, layers depending upon level of anti-reflective performance desired from the coating. Select both anti-reflective materials as well as film thickness for each layer based on the classic anti-reflective design principles such as those found in Chapter 42 (Optical Properties of Films and Coatings), Handbook of Optics (Volume I), by Optical Society of America, McGraw-Hill (1994).

The lens of the fourth aspect may, in addition to the hydrogenated vinyl aromatic block copolymer, also comprise one or more conventional additives such as an antioxidant, an ultraviolet (UV) light stabilizer, a plasticizer, a release agent or any other conventional additive used in fabricating an article of manufacture, especially an injection-molded article of manufacture such as a lens.

### EXAMPLES

The following examples illustrate, but do not limit, the present invention. All parts and percentages are based upon weight, unless otherwise stated. All temperatures are in ° C. Examples (Ex) of the present invention are designated by Arabic numerals and Comparative

Examples (Comp Ex or CEx) are designated by capital alphabetic letters. Unless otherwise stated herein, “room temperature” and “ambient temperature” are nominally 25° C.

Measure birefringence of injection molded disks that have a diameter of two inches (5.08 centimeters (cm)) and a thickness of ⅛ inch (0.32 cm) using an EXICOR™ 150ATS birefringence measurement system (Hinds Instrument) at a wavelength of 633 nm. A value denominated as “average birefringence” or “ Δn₀” refers to an average of birefringence value measurements for three disks, each measurement being made proximate to an axis of a different molded disk.

Injection molded disks tend to have higher birefringence values for portions of the disks located close or proximate to an injection gate (“birefringence close to gate” or “Δn_{gate}” than for portions of the disks located away or distant from the injection gate. As used herein, “birefringence close to gate” or “Δn_{gate}” refers to birefringence measurements made at a point located five millimeters (mm) away from the injection gate. Δn_{gate} values reported in Table 2 below represent an average of measurements made on at least three injection molded disks.

As used herein, an average birefringence value (Δn₀) of less than or equal to 6×10⁻⁶ merits a good rating; and a Δn₀ of more than 6×10⁻⁶ nm earns an inferior or failing rating. As a general rule, (Δn₀) values in excess of 6×10⁻⁶ also have a Δn_{gate} value well in excess of 6×10⁻⁶. A resin that gives such failing values tends to be unsuitable for use in many lens applications, especially those that require a birefringence that is both substantially uniform and low (less than 6×10⁻⁶) throughout a lens. Such resins become even less desirable as lens size decreases.

Measure Unnotched Izod impact in accord with ASTM D-256. An Unnotched Izod (UNI) of 1.8 ft-lb/in (315.2 N/m) or more equals good whereas a UNI of less than 1.8 ft-lb/in (315.2 N/m) earns a poor or failing rating.

Use DSC analysis and a model Q1000 differential scanning calorimeter (TA Instruments, Inc.) to determine wt % of crystallinity (X%) with respect to the total weight of a hydrogenated styrenic block copolymer or film sample. General principles of DSC measurements and applications of DSC to studying semi-crystalline polymers are described in standard texts (e.g., E. A. Turi, ed., Thermal Characterization of Polymeric Materials, Academic Press, 1981).

Calibrate the model Q1000 differential scanning calorimeter first with indium and then with water in accord with standard procedures recommended for the Q1000 to ensure that heat of fusion (H_{f}) and onset of melting temperature for indium are within, respectively, 0.5 joules per gram (J/g) and 0.5° C. of prescribed standards (28.71 J/g and 156.6° C.) and that onset of melting temperature for water is within 0.5° C. of 0° C.

Press polymer samples into a thin film at a temperature of 230° C. Place a piece of the thin film that has a weight of from 5 milligrams (mg) to 8 mg in the differential scanning calorimeter's sample pan. Crimp a lid on the pan to ensure a closed atmosphere.

Place the sample pan in the differential scanning calorimeter's cell and heat contents of the pan at a rate of about 100° C./min to a temperature of 230° C. Maintain contents of the pan at that temperature for approximately three minutes, then cool the pan contents at a rate of 10° C./min to a temperature of −60° C. Keep the pan contents isothermally at −60° C. for three minutes and then heat the contents at a rate of 10° C./min up to 230° C. in a step designated as the “second heating”.

Analyze enthalpy curves that result from the second heating of polymer film samples as described above for peak melt temperature, onset and peak crystallization temperatures, and H_{f} (also known as heat of melting). Measure H_{f} in units of joules per gram (J/g) by integrating the area under the melting endotherm from the beginning of melting to the end of melting by using a linear baseline.

A 100% crystalline polyethylene has an art-recognized H_{f} of 292 J/g. Calculate wt % of crystallinity (X%) with respect to the total weight of a hydrogenated styrene block copolymer or film sample by using the following equation:

X%=(H_{f}/292)×100%

Determine 1,2-butadiene (also known as 1,2-vinyl) content of hydrogenated styrenic block copolymers prior to hydrogenation using Nuclear Magnetic Resonance (NMR) spectroscopy and a Varian INOVA™ 300 NMR spectrometer that operates with a pulse delay of 10 seconds to ensure complete relaxation of protons for quantitative integrations and samples of approximately 40 milligrams of polymer in one milliliter of deuterated chloroform (CDCl₃) solvent. Report chemical shifts relative to a tetramethylsilane (TMS) standard where chemical shifts for a 1,4-double bond region fall between 5.2 and 6.0 parts per million (ppm) and chemical shifts for a 1,2-double bond region fall between 4.8 ppm and 5.1 ppm. Integrate peaks in the 1,2-double bond region to determine a value, divide that value by two and designate that as “A”. Integrate peaks for the 1,4-double bond region to determine a second value, determine a difference between the second value and A, then divide the difference by two and designate that as “B”. Calculate the percent 1,2-vinyl or percent 1,2-butadiene content according to a formula as follows:

% 1,2=(A/(A+B))×100%

Resins that yield poor or failing results or evaluations appear to provide practical production challenges similar to those resulting from use of some commercial resins. Those challenges include difficulty in molding (very probably because of excess brittleness) due to sprue breakage and consequent interruption of molding operations.

### Ex 1-Ex 2 and CE A-CE O

Use a 25 ton (22,727 kilogram) Arburg injection molding machine equipped with a single cavity end-gated ASTM (American Society for Testing and Materials) tensile bar mold to prepare a plurality of ASTM Type I tensile test specimens (also known as “tensile bars”) from several resins, each described in some detail below, with variable melt temperature as shown in Table 1 below and a mold temperature of 38° C. Table 1 also includes data obtained by subjecting the tensile test specimens to measurements for birefringence and Izod impact properties (in units of ft-lb/in and J/m).

Measure birefringence proximate to a tensile bar's middle point (e.g. a geometric center or point equidistant from tensile bar ends, equidistant from tensile bar sides and located on a major planar surface of the tensile bar) and report birefringence in Table 1 as an average of birefringence measurements made on at least three tensile bars.

Cut an Izod test specimen that has a length of 2.5 inches (6.4 cm) and a width of 0.5 inch (1.3 cm) from each of several tensile bars proximate to the middle point of each tensile bar. Determine unnotched Izod impact of each specimen in accord with ASTM method D-256. Izod impact values presented in Table 2 below represent an average of measurements made for at least four different test specimens.

In addition to the process conditions shown in Table 1 below, target a mold fill time of 1.3 seconds to attain a mold filling level of approximately 99 percent, based upon total mold cavity volume, and a cavity hold pressure of 5000 psi (34.3 megapascals (MPa).

For purposes of overall suitability evaluations as shown in Table 1, a resin that earns a poor or failing rating for either birefringence or unnotched Izod impact (also referred to sometimes as “Izod toughness”) has an overall failing rating.

Prepare Resins A through E And CR 4 through CR 6 below by sequential anionic polymerization of styrene and a conjugated diene in cyclohexane as a solvent. Conduct sequential polymerization by preparing a cyclohexane solution of a first purified monomer (e.g. styrene) required to complete a first polymer block, heating the solution to the polymerization temperature, and adding an alkyl lithium initiator. Polymerization proceeds until the monomer is exhausted, after which time a second purified monomer (e.g. a conjugated diene) is added and polymerization continues until the second monomer is exhausted. This process is repeated by alternating the first and second monomers until the block copolymer sequence (e.g. triblock or pentablock) is realized, after which the polymerization is terminated with an acidic species such as an alcohol, effectively protonating a living or chain end of the block copolymer sequence and producing a lithium salt as a by-product.

Pentablock copolymers that contain 8 wt % 1,2-vinyl content in the polybutadiene block are made by the polymerization of monomers in neat cyclohexane initiated by sec-butyl lithium, as is the polyisoprene containing pentablock copolymer. Pentablock copolymers containing 10 wt % or higher 1,2-vinyl content are prepared by sequential polymerization initiated by n-butyl lithium, and tetrahydrofuran (THF) is added to the polymerization reactor to assist in the initiation process. The level of 1,2-vinyl content can be changed by modifying the molar concentration ratios of THF to n-butyl lithium, as described in Macromolecules, 1998, 31, pp. 394-402.

Resin A is a developmental hydrogenated pentablock resin having a Mn of 60,000, a polymerized styrene content (prior to hydrogenation) of 90 wt %, based on total resin weight, and a 1,2-vinyl content (prior to hydrogenation), based upon total butadiene content, of 8 wt %. The hydrogenated resin has a level of hydrogenation in excess of 99.5%, based upon total unsaturated bonds present in the resin prior to hydrogenation. The resin has a crystallinity that is too low to measure via DSC.

Resin B is a developmental hydrogenated pentablock resin having a Mn of 50,000, a polymerized styrene content (prior to hydrogenation) of 85 wt %, based on total resin weight, and a 1,2-vinyl content (prior to hydrogenation), based upon total butadiene content, of 8 wt %. The hydrogenated resin has a level of hydrogenation in excess of 99.5%, based upon total unsaturated bonds present in the resin prior to hydrogenation. The hydrogenated resin also has a crystallinity of 0.3 wt %, based upon weight of total polymer weight.

Resin C is a developmental hydrogenated pentablock resin having a Mn of 55,000, a polymerized styrene content (prior to hydrogenation) of 85 wt %, based on total resin weight, and a 1,2-vinyl content (prior to hydrogenation), based upon total butadiene content, of 8 wt %. The hydrogenated resin has a level of hydrogenation in excess of 99.5%, based upon total unsaturated bonds present in the resin prior to hydrogenation. The hydrogenated resin also has a crystallinity of 0.5 wt %, based upon weight of total polymer weight.

Resin D is a developmental hydrogenated pentablock resin having a Mn of 58,000, a polymerized styrene content (prior to hydrogenation) of 85 wt %, based on total resin weight, and a 1,2-vinyl content (prior to hydrogenation), based upon total butadiene content, of 12 wt %. The hydrogenated resin has a level of hydrogenation in excess of 99.5%, based upon total unsaturated bonds present in the resin prior to hydrogenation. The hydrogenated resin also has a crystallinity of 0.6 wt %, based upon weight of total polymer weight.

Resin E is a developmental hydrogenated pentablock resin having a Mn of 80,000, a polymerized styrene content (prior to hydrogenation) of 75 wt %, based on total resin weight, and an isoprene content (prior to hydrogenation), based upon total resin weight, of 25 wt %. The hydrogenated resin has a level of hydrogenation in excess of 99.5%, based upon total unsaturated bonds present in the resin prior to hydrogenation. The hydrogenated resin also has a crystallinity of 0.0 wt %, based upon weight of total polymer weight.

Comparative Resin 1 (CR 1) is a cyclic olefin polymer (COP) resin that is commercially available from Nippon Zeon under the trade designation ZEONEX™ E48R. The resin is an amorphous polymer and has no measurable amount of crystallinity.

CR 2 is a cyclic olefin polymer (COP) resin that is commercially available from Nippon Zeon under the trade designation ZEONEX™ 330R. CR2, like CR1, is an amorphous polymer and has no measurable amount of crystallinity.

CR 3 is a random cyclic olefin copolymer (COC) resin that is commercially available from Ticona under the trade designation TOPAS™ 5013. CR3, like CR1 and CR2, is an amorphous polymer and has no measurable amount of crystallinity.

CR 4 is a developmental hydrogenated pentablock resin having a Mn of 60,000, a polymerized styrene content (prior to hydrogenation) of 85 wt %, based on total resin weight, and a 1,2-vinyl content (prior to hydrogenation), based upon total butadiene content, of 8 wt %. The hydrogenated resin has a level of hydrogenation in excess of 99.5%, based upon total unsaturated bonds present in the resin prior to hydrogenation. The hydrogenated resin also has a crystallinity of 1.2 wt %, based upon weight of total polymer weight.

CR 5 is a developmental hydrogenated pentablock resin having a Mn of 55,000, a polymerized styrene content (prior to hydrogenation) of 81 wt %, based on total resin weight, and a 1,2-vinyl content (prior to hydrogenation), based upon total butadiene content, of 10 wt %. The hydrogenated resin has a level of hydrogenation in excess of 99.5%, based upon total unsaturated bonds present in the resin prior to hydrogenation. The hydrogenated resin also has a crystallinity of 1.3 wt %, based upon weight of total polymer weight.

CR 6 is a developmental hydrogenated pentablock resin having a Mn of 60,000, a polymerized styrene content (prior to hydrogenation) of 81 wt %, based on total resin weight, and a 1,2-vinyl content (prior to hydrogenation), based upon total butadiene content, of 10 wt %. The hydrogenated resin has a level of hydrogenation in excess of 99.5%, based upon total unsaturated bonds present in the resin prior to hydrogenation. The hydrogenated resin also has a crystallinity of 2.5 wt %, based upon weight of total polymer weight.

CR 7 is a COP commercially available from Nippon Zeon under the trade designation ZEONEX™ 480R. Like CR 1 through CR 3, CR 7 is an amorphous polymer with no measurable amount of crystallinity.

TABLE 1

| | | Melt | Birefrin- | UNI | |
|---|---|---|---|---|---|
| Ex/ | | Temp | gence | (ft-lb/in)/ | Pass (P)/ |
| CE | Resin | (° C.) | (×10⁻⁶) | (J/m) | Fail (F) |
| 1 | C | 250 | 0.38 | 2.2/117.3 | P |
| 2 | C | 280 | 3.43 | 2.1/111.9 | P |
| CE A | C | 310 | 6.87 | nd* | F |
| CE B | CR 5 | 250 | 14.8 | nd* | F |
| CE C | CR 5 | 280 | 9.37 | 2.1/111.9 | F |
| CE D | CR 5 | 310 | 2.78 | nd* | P |
| CE E | CR 4 | 250 | 9.69 | 3.6/191.9 | F |
| CE F | CR 4 | 280 | 6.42 | 2.9/154.6 | F |
| CE G | CR 4 | 310 | 10.02 | nd* | F |
| CE H | CR 6 | 250 | 31.94 | 3.4/181.2 | F |
| CE I | CR 6 | 280 | 35.31 | 2.5/133.2 | F |
| CE J | CR 6 | 310 | 34.53 | nd* | F |
| CE K | CR 3 | 250 | 21.17 | 1.5/80.0 | F |
| CE L | CR 3 | 280 | 8.41 | 1.3/69.3 | F |
| CE M | CR 3 | 310 | 8.82 | nd* | F |
| CE N | CR 1 | 250 | 42.52 | 9.5/506.4 | F |
| CE O | CR 1 | 280 | 33.01 | 9.4/501.0 | F |
| CE P | CR 1 | 310 | 15.59 | nd* | F |
| CE Q | CR 7 | 280 | 42.52 | nd* | F |

nd* means not determined

The data in Table 1 demonstrate several points. First, a comparison of Ex 1 and 2, wherein Resin C has a crystallinity of 0.48 wt %, CE E through CE G, wherein CR 4 has a crystallinity of 1.2 wt %, shows that an increase in crystallinity leads to birefringence values in excess of 6×10⁻⁶ across a melt temperature range of from 250° C. to 310° C. CE B and CE C, both based upon CR 5 which has a crystallinity of 1.3 wt %, also show birefringence values in excess of 6×10⁻⁶ for melt temperatures of, respectively, 250° C. and 280° C. CE D, also based upon CR 5, appears to be an anomaly, possibly due to thermal degradation of the hydrogenated block copolymer at a melt temperature of 310° C. Thermal degradation, if present, may lead to one or more of a reduction of block copolymer Mₙ and an increase in phase mixing between hydrogenated styrene blocks and hydrogenated butadiene blocks, either of which appears to substantially reduce a tendency for the hydrogenated butadiene blocks to crystallize. Second, COP resins (CR 1) used in CE N through CE P and COC resins (CR 3) used in CE K through CE M have a much higher birefringence than Resin C, a hydrogenated styrenic block copolymer as used in Ex 1 and Ex 2. In addition, CR 3 has a lower UNI than Resin C. A birefringence in excess of 6×10⁻⁶ has an adverse impact upon performance of injection molded lenses. A low UNI value can lead to a disruption of continuous molding operations due to fabrication issues such as sprue breakage. Third, Resin C provides a birefringence well below 6×10⁻⁶ at melt temperatures as low as 250° C. whereas COP resins (CR 1) and COC resins (CR 3) remain well above 6×10⁻⁶ even at melt temperatures as high as 310° C. Skilled artisans understand that a reduction in polymer melt temperature can lead to a reduction in lens molding cycle time and, consequently, an increase in lens production rates.

### Ex 3 through Ex 22 and CE R through CE X

Replicate Ex 1 using the same apparatus, a cycle time of 60 seconds, and melt and mold temperatures as shown in Table 2 below, to prepare a plurality of molded circular disks (2 inch (5.1 centimeter) diameter and ⅛ inch (0.3 centimeter) thick). Table 2 also includes data for Δn₀ and Δn_{gate}, both of which are explained above. For best lens performance, a low degree of birefringence throughout the entire lens area is highly desirable. Thus, a high Δn_{gate} deteriorates the overall lens performance.

TABLE 2

| | | Melt | Mold | Average | Birefrin- | Room Temper- | | |
|---|---|---|---|---|---|---|---|---|
| | | Temper- | Temper- | Birefrin- | gence Close | ature UNI | | |
| Ex/ | | ature | ature | gence | to Gate | (ft-lb/in)/ | | Pass/ |
| CE | Resin | (° C.) | (° C.) | Δn₀ (×10⁻⁶) | Δn_{gate} (×10⁻⁶) | (J/m) | Comment | Fail |
| 3 | A | 250 | 90 | 0.48 | 1.35 | nd* | — | Pass |
| 4 | A | 250 | 80 | 0.87 | 1.56 | nd* | — | Pass |
| 5 | A | 250 | 60 | 1.11 | 3.87 | nd* | — | Pass |
| 6 | A | 250 | 38 | 1.23 | 3.99 | nd* | — | Pass |
| 7 | A | 280 | 90 | 1.02 | 2.07 | nd* | — | Pass |
| 8 | A | 280 | 80 | 1.23 | 2.49 | nd* | — | Pass |
| 9 | A | 280 | 60 | 1.38 | 1.02 | nd* | — | Pass |
| 10 | A | 280 | 38 | 0.69 | 1.44 | nd* | — | Pass |
| 11 | B | 250 | 90 | 1.02 | 1.38 | nd* | — | Pass |
| 12 | B | 250 | 80 | 0.87 | 0.93 | 3.3/175.9 | — | Pass |
| 13 | B | 250 | 60 | 1.02 | 1.38 | nd* | — | Pass |
| 14 | B | 250 | 38 | 0.78 | 1.38 | nd* | — | Pass |
| 15 | B | 280 | 90 | 1.14 | 2.97 | nd* | — | Pass |
| 16 | B | 280 | 80 | 0.69 | 1.38 | nd* | — | Pass |
| 17 | B | 280 | 60 | 0.69 | 1.83 | nd* | — | Pass |
| 18 | B | 280 | 38 | 0.69 | 1.14 | nd* | — | Pass |
| 19 | C | 250 | 90 | 1.83 | 3.78 | nd* | — | Pass |
| 20 | C | 250 | 80 | 1.8 | 4.8 | 2.1/111.9 | — | Pass |
| 21 | D | 280 | 80 | 0.71 | 3.16 | 2.55/135.9 | — | Pass |
| 22 | E | 280 | 60 | 1.84 | 6.06 | 2.3/122.6 | — | Pass |
| CE R | CR 1 | 270 | 115 | 6.72 | 23.05 | 9.42/502.1 | high Δn₀ | Fail |
| | | | | | | | and Δn_{gate} | |
| CE S | CR 2 | 280 | 121 | 1.95 | 11.36 | 1.53/81.5 | low UNI | Fail |
| CE T | CR 3 | 280 | 80 | 8.64 | 11.2 | 1.29/68.8 | low UNI | Fail |
| CE U | CR 4 | 280 | 80 | 9.6 | >15 | 2.2/117.3 | high Δn₀ | Fail |
| | | | | | | | and Δn_{gate} | |
| CE V | CR 5 | 280 | 80 | 8.76 | >15 | nd* | high Δn₀ | Fail |
| | | | | | | | and Δn_{gate} | |
| CE W | CR 6 | 280 | 80 | >25 | nd* | 2.2/117.3 | high Δn₀ | Fail |
| | | | | | | | and Δn_{gate} | |
| CE X | E | 250 | 38 | 7.07 | 27.4 | 2.2/117.3 | high Δn₀ | Fail |
| | | | | | | | and Δn_{gate} | |

— means no comment.
*nd means not determined

The data in Table 2 demonstrate that lens-forming, thermoplastic compositions of matter that have a crystallinity of less than 1 percent, especially such compositions that comprise a hydrogenated styrenic block copolymer resin such as any of Resins A through E (Ex 3-Ex 22), have a wide processing window in terms of both polymer melt temperature and mold temperature. Ex 29 shows that a fully hydrogenated styrene-isoprene block copolymer composition also shows low overall birefringence in both central region as well as in gate area.

By way of contrast, COCs and COPs (CE R through CE T) provide, relative to Ex 3-Ex 22, compositions of matter that, while amorphous, have inferior performance in terms of at least one of: 1) high Δn₀; 2) high Δn_{gate}; and 3) low Izod impact value.

The data in Table 2 also demonstrate that lens-forming thermoplastic compositions of matter which comprise a substantially fully hydrogenated styrene-conjugated diene block copolymer resin with a crystallinity of more than 1 wt % (e.g. CE U-CE W) tend to have a considerably higher Δn_{gate} than compositions that are identical save for use of a substantially fully hydrogenated styrene-conjugated diene block copolymer resin that has a crystallinity of less than 1 wt % (e.g. Ex 3). The compositions of CE U through CE W are less suitable than those of, for example, any of Ex 3-Ex 22 for use in lens applications that require low birefringence.

The data in Table 2 further demonstrate that polymer melt processing temperature can affect the birefringence of a molded article. See e.g., Ex 22 and CE X, both of which comprise the same Resin E, but use different melt processing temperatures. CE X appears to show that, for Resin E, a melt processing temperature of 250° C. is less than optimal as reflected by undesirably high values for both Δn₀ and Δn_{gate}. A possible explanation for this behavior stems from Resin E's diene content and Mn, both of which exceed those of Resins A through D and both of which appear to promote a stronger microphase separation, possibly in a morphological form known as “cylindrical morphology”.

Resins A through D have broader polymer melt processing temperature windows, an indication that one may modify resin composition, e.g. by increasing styrene content, to reduce melt processing temperature sensitivity.

1. (canceled)

2. (canceled)

3. A thermoplastic composition of matter, the composition comprising a hydrogenated vinyl aromatic monomer/conjugated diene block copolymer that has a crystallinity of from 0 percent to less than 1 percent, in each case as measured in accord with differential scanning calorimetry, and an average birefringence, measured at a wavelength of 633 nanometers, within a range of from 0 to less than 6×10⁻⁶.

4. The composition of matter of claim 3, wherein the hydrogenated vinyl aromatic monomer/conjugated diene block copolymer, prior to hydrogenation, comprises an amount of polymerized butadiene monomer sufficient to provide a crystallinity of greater than 0 percent while maintaining the birefringence, measured at a wavelength of 633 nanometers, within the range of from greater than 0 to less than 6×10⁻⁶.

5. The composition of matter of claim 3, wherein the conjugated diene is isoprene.

6. The composition of matter of claim 3, wherein the block copolymer, prior to hydrogenation, comprises at least three distinct blocks of polymerized and hydrogenated vinyl aromatic monomer and at least two blocks of polymerized and hydrogenated conjugated diene monomer, and has a polymerized vinyl aromatic monomer content of from more than 70 percent by weight to less than 95 percent by weight and a polymerized diene monomer content of from more than 5 percent by weight to less than 30 percent by weight, each weight percent being based upon total block copolymer weight, provided polymerized vinyl aromatic monomer content and polymerized diene monomer content, when taken together, equal 100 percent by weight.

7. (canceled)

8. (canceled)

9. (canceled)

10. The composition of matter of claim 3, wherein the vinyl aromatic monomer is styrene.

11. (canceled)

12. (canceled)

13. (canceled)

14. The composition of claim 3, wherein the hydrogenated block copolymer has an unnotched izod impact of at least 1.8 ft-lb/in (95.9 J/m).

15. A method of preparing a lens, the method comprising:
a. providing a polymer melt that comprises a hydrogenated vinyl aromatic block copolymer that has a crystallinity of from 0 percent to less than 1 percent, in each case as measured in accord with DSC, an average birefringence, measured at a wavelength of 633 nanometers, within a range of from greater than 0 to less than 6×10⁻⁶, and a glass transition temperature within a range of from 115° C. to 145° C., and the polymer melt being at a melt temperature sufficient to provide a flowable viscosity, yet insufficient to cause heat-induced copolymer chain scission or degradation;
b. molding the polymer melt into an optical lens at a temperature within a temperature range of from the glass transition temperature minus 20° C. to the glass transition temperature minus 90° C., whereby the optical lens has a substantially uniform birefringence throughout its cross-section (from top to bottom thereof) and across its length and width.

16. The method of claim 15, wherein the optical lens has a thickness of at least one millimeter.

17. The method of claim 15, wherein the polymer melt is at a temperature within a range of from 200° C. to less than 310° C.

18. (canceled)

19. The method of claim 15, wherein step b. occurs at a mold temperature of less than 100° C.

20. The method of claim 15, wherein the hydrogenated vinyl aromatic block copolymer comprises, prior to hydrogenation, a) a styrene/isoprene pentablock copolymer or b) a styrene/butadiene pentablock copolymer.

21. (canceled)

22. A lens, the lens comprising the thermoplastic composition of matter of claim 3 and having at least one of a) a thickness of more than one millimeter and b) a substantially uniform birefringence throughout its cross-section and across its length and width.

23. The lens of claim 22, wherein the thermoplastic composition of matter further comprises at least one of a hydrogenated vinyl aromatic homopolymer or a hydrogenated random copolymer of a vinyl aromatic monomer and a conjugated diene monomer.

24. The lens of claim 22, wherein the lens is an optical lens that has at least one of an irregular surface configuration, a non-uniform thickness or an irregular and non-uniform cross-section.

25. (canceled)

26. (canceled)

27. (canceled)

28. The lens of claim 22, further comprising an anti-reflective coating on at least one surface portion of the lens.
